(19) United States
(12) Patent Application Publication
(10) Pub. No.: US 2018/0328954 A1
(43) Pub. Date: Nov. 15, 2018

(54) SENSOR AND METHOD OF MANUFACTURE THEREOF

(71) Applicant: Hextern Sensor Technologies Ltd, Mirfield Yorkshire (GB)

(72) Inventor: Calvin Cox, Mirfield Yorkshire (GB)

(21) Appl. No.: 15/775,750

(22) PCT Filed: Aug. 4, 2016
(86) PCT No.: PCT/GB2016/052394

§ 371 Date: May 11, 2018

(30) Foreign Application Priority Data
Aug. 5, 2015 (GB) 1513843.1

(51) Int. Cl. G01P 3/483; G01D 5/24; G01D 5/241

(52) U.S. Cl. CPC G01P 3/483; G01D 5/241; G01D 5/2405

(57) ABSTRACT

A sensor suitable for sensing the relative movement between at least part of the sensor and one or more target objects. The sensor including at least one polarised or at least partially polarised dielectric material and at least one electrode. The interaction of the one or more target objects with the static electric field of the dielectric material produces a signal or voltage change in the electrode.

The invention to which this application relates is a sensor for detecting the motion of objects, in particular, sensors incorporating one or more dielectric materials.

Although the following description refers to the provision of sensors suitable for use in the automotive industry, the person skilled in the art will appreciate that the present invention can be applied in other industries where sensors are required to operate in hostile environments, including aerospace and/or the like.

Sensors that operate in hostile environments are typically based on inductive technologies. However, these conventional sensors have severe limitations for example their inability to detect slow speeds, inability to detect non-ferrous metals or operate at temperatures above 100° C.

It is therefore an aim of the present invention to provide a sensor that addresses the abovementioned problems.

It is a further aim of the present invention to provide a method of manufacturing a sensor that addresses the abovementioned problems.

It is yet a further aim of the present invention to provide a method of using a sensor that addresses the above mentioned problems.

According to a first aspect of the invention there is provided a sensor suitable for sensing the relative movement between at least part of the sensor and one or more target objects in use, said sensor including at least one polarised or at least partially polarised dielectric material and at least one electrode wherein the interaction of the one or more target objects with the static electric field of the dielectric material produces a signal or voltage change in the electrode.

Thus, when a target object, intersects the electrostatic field radiated from a sensing dielectric the interaction produces an imbalance or displacement current within the dielectric which causes a voltage change at an electrode in contact with the surface of the dielectric. As such, the relative movement of the target object can be detected and/or measured. Typically the electrode is in contact with the opposite side of the dielectric to which the interaction occurs.

Further typically the displacement current is expressed as D=ε0E+P, where D is the displacement current, ε0 is the permittivity of air, E is the electric field density and P is the polarisation of the dielectric medium.

In one embodiment the polarisation of the dielectric material is induced by an electrode. Typically the electrode is at least one of the sensor electrodes. Further typically once the polarisation is induced the potential is removed or reduced such that the active charge remains on the dielectric.

In one embodiment the sensor includes control circuitry. Typically the circuitry includes a reference voltage source. Further typically if the amplitude of the displacement current falls below a prescribed or predetermined value presented by the reference voltage then the control circuitry will generate a charging current or pulses until the dielectric charge is restored to, or above, the prescribed or predetermined value.

In one embodiment the charging current or pulses is in the form of pulsed DC.

Thus the charge on the dielectric can be restored using control circuitry if the dielectric loses charge, due to the action of water in the air for example.

In one embodiment one or more of the dielectric material is an electret.

In one embodiment at least one dielectric and electrode are in contact. In an alternative embodiment the dielectric and electrode are not in contact or are a spaced distance apart. The skilled person will appreciate that the dielectric material and the electrode of the sensor are in electrostatic contact for a period of time in order to sense or detect the relative movement.

In one embodiment the dielectric material is, and/or is associated with, the one or more objects to be detected.

In one embodiment the electrode includes a plate and/or is a plate electrode. Typically the plate is a substantially planer portion of the electrode.

In one embodiment the dielectric material forms a surface or layer on the electrode.

The sensing dielectric can radiate a positive (P type) or a negative (N type) charge field according to the polarity of the potential connected to the electrode or by the polarity of the field used to create the electret.

In one embodiment at least part of the electrode and/or the dielectric is a coating. Typically the electrode and/or the dielectric is formed as a surface coating. Further typically the sensing dielectric material is applied as a surface coating on an electrode plate and/or object.

In one embodiment the sensor includes a series of dielectrics or dielectric materials. Typically the two or more dielectrics are connected in parallel and thus the signal produced is enhanced and/or impedance is reduced. Further typically the series of dielectrics are connected by a common electrode.

In one embodiment the dielectric materials are connected by a common electrode. This may be a full or partial band or ring to facilitate a composite signal.

In one embodiment the dielectric materials are connected to and/or in communication with separate electrodes. Typically the electrodes are substantially independent. Further typically different voltages can be applied to each electrode and/or the electrode can be earthed.

Typically the charge on the dielectric is produced by either; applying a charging potential to the electrode; using a triboelectrically reactive material; or using an electret material to store charge. Further typically the charge on the dielectric is produced on an outer or sensing surface of the dielectric.

In one embodiment the sensor includes two or more dielectrics, at least one of said dielectrics being a positively charged (P type) and at least one negatively charged (N type). Typically the interaction with the electric field produces signals that are of opposite polarity. Further typically such signals can be utilised by differential amplification to reduce noise.

Typically the sensor is connected or coupled to an amplifier. In one embodiment the amplifier is a differential amplifier.

In one embodiment the sensing electrode is energised by an external voltage. Typically the sensor includes a resistor. Further typically the resistor is connected in series. Often the resistor needs to be several Mega ohms for a sufficiently high impedance field and the signal is taken directly from the high voltage electrode for amplification.

In one embodiment the sensor includes a transistor. Typically the emitter base junction of a bipolar transistor is used as the field source to polarise the sensing dielectric. This has the advantage of combining the sensing mechanism and field generator.

In one embodiment the sensor includes a shared dielectric or dielectric which is common and/or shared by at least two electrodes. Typically a polarising electrode is fed from a low impedance source. Further typically the sensing electrode has a high impedance.

In one embodiment the low impedance polarising voltage is applied directly to an energising electrode which creates a surface charge on the dielectric. Typically charge extends above the sensing dielectric. Further typically the sensing electrode applies no loading to the field. This is so as not to attenuate the signal. Said signal is usually sufficient to control a bipolar transistor configured as an impedance buffer to provide a 5 KΩ output.

In one embodiment the sensor has a cylindrical or coaxial arrangement. Typically the coaxial arrangement comprises an inner core which forms the sensing electrode. Further typically the outer screen provides the polarisation for the dielectric covering the sensing surface of the probe.

In one embodiment the dielectric includes at least one protective surface or barrier layer.

In one embodiment the sensor includes a protective dielectric layer that is incapable of transporting ions but allows the electric field of the sensing polarised dielectric to permeate.

In one embodiment the electrode can be positioned or configured to act as a protective layer or barrier to the dielectric.

In one embodiment the electrode is metalized and/or located on a substantially flexible membrane or surface. Typically any displacement between the electrode and target object results in a reduced signal amplitude.

In one embodiment a thermistor is used to compensate for differences in thermal flexibility of the membrane.

In one embodiment the sensor includes a housing. In one embodiment the sensor is a probe.

In a second aspect of the invention there is provided a mass airflow sensor, suitable for use in an engine turbocharger, said sensor including at least one polarised or at least partially polarised dielectric material and at least one electrode wherein the interaction of the turbo blades and/or air pressure with the static electric field of the dielectric material produces a signal or voltage change in the electrode.

In a third aspect of the invention there is provided a method of producing a motion sensor for detecting and or measuring the relative movement between said sensor and one or more objects, said sensor comprising an electrode and a polarisable or at least partially polarised dielectric wherein the dielectric is applied to the electrode and/or the object.

In one embodiment the dielectric and/or the electrode is coated on to a substrate and/or object.

In one embodiment the dielectric is coated onto the electrode or vice versa, Typically the dielectric and/or electrode are formed by printing, spraying, transferring and/or the like.

In an aspect of the present invention there is provided a sensing technique that utilises the surface charge of certain dielectrics to produce an interacting field with mobile targets to electrostatically induce displacement current.

Typically the mobile target may comprise a material capable of influencing a static electric field emanating from a dielectric.

Further typically dielectrics whose surfaces have been charged with opposite polarities will produce signals of substantially simultaneously opposite polarities from a common target suitable for differential amplification.

In one embodiment dielectrics of the same polarity can be positioned so as to produce a 180° phase shift for use with differential amplification.

Typically the sensor and target can be implemented as surface coatings.

In one embodiment applying a reactive dielectric coating to a disc allows the rotation or a flat or substantially planar surface to be sensed.

In one embodiment negative and positive polarisation of dielectrics can be used to generate phase and multi node applications where the ‘collector’ electrode can comprise multiple dielectrics.

In one embodiment placing the dielectric behind an exposed electrode spaced by an air gap of low permittivity material protects the dielectric's surface charge from the effects of moisture.

A differential circuit can be implemented by combining the signal from a single sensing dielectric (with positive feedback) with an electrode connected via a capacitance of similar value to the dielectric connected to a node which functions as an antenna for rejecting common mode noise.

Typically signal amplitude is a function of sensing distance. Therefore, the sensor can be adapted or configured to function as a proximity sensor or to detect damaged blades of an impeller.

Further typically signal amplitude is a function of humidity. Therefore the sensor can be adapted to detect areas of varying moisture content such as different tissues and/or tumours.

In one embodiment signals obtained by the sensor can be capacitively coupled from within a sealed enclosure by fitting a dielectric to the wall with plate electrodes internally and externally.

Typically non-filament yarns, such as a natural fibre, will trap charge around its hairs which will produce a ‘white noise’ type signal when detected using the present invention. Cross correlation can then determine the speed.

Typically at least the sensing electrode is connected to circuitry and in particular signal processing circuitry. Further typically said circuitry includes a signal amplifier. Typically the circuitry is grounded.

In one embodiment the sensor incorporates at least two dielectrics and two electrodes wherein one dielectric is active whilst the other is inactive.

According to a fourth aspect of the invention there is provided a method of manufacturing a sensor, said sensor including at least one polarised or at least partially polarised dielectric material and at least one electrode wherein said method includes the step of positioning the dielectric material and/or electrode such that the interaction of the one or more target objects with the electric field of the dielectric material produces a signal or voltage change in the electrode.

According to a further aspect of the invention there is provided a sensor suitable for sensing the relative movement between at least part of the sensor and one or more objects in use, said sensor including at least one polarised or at least partially polarised dielectric material and at least one electrode wherein the interaction of the one or more target objects with the electric field of the dielectric material produces a signal or voltage change in the electrode.

Specific embodiments of the invention are now described with reference to the following figures wherein:

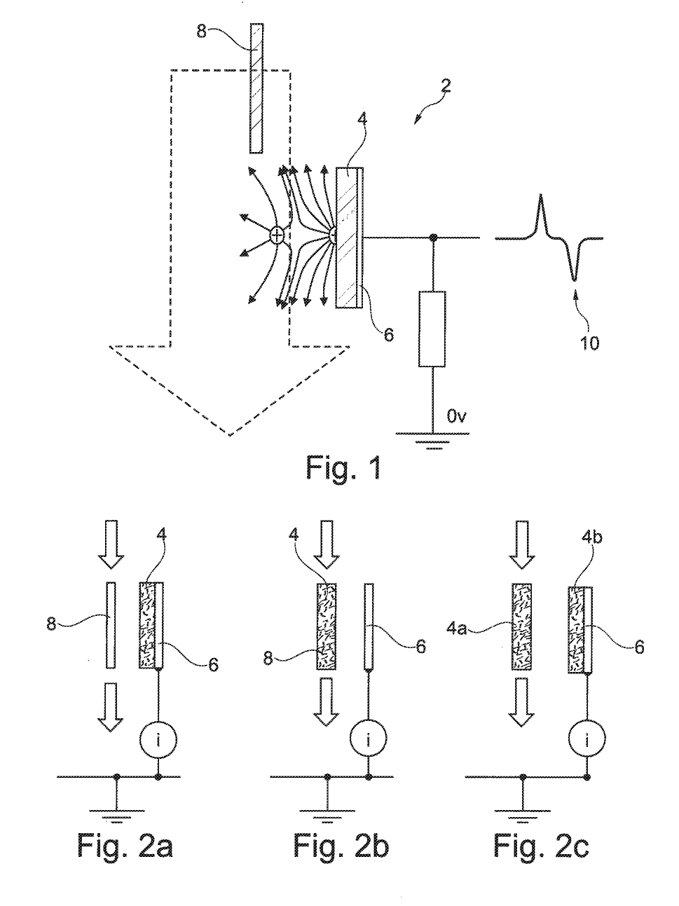

FIG. 1 shows a diagram of a sensor in accordance with one embodiment of the invention;

FIGS. 2a-2c show three embodiment or configurations of sensor in accordance with the invention;

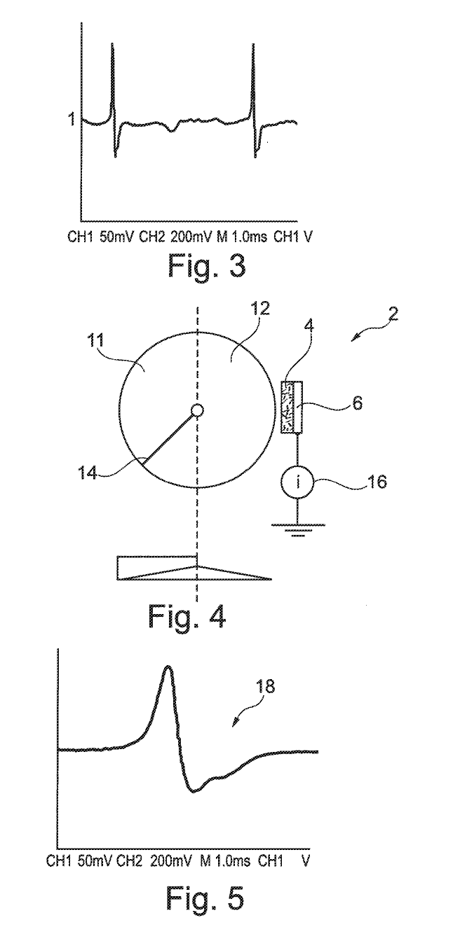

FIG. 3 shows a plot of current flow in accordance with one embodiment of the invention;

FIG. 4 shows a diagram of an apparatus to determine signal propagation in accordance with one embodiment of the invention;

FIG. 5 shows a plot of current flow from the induction in the electrode in accordance with one aspect of the invention;

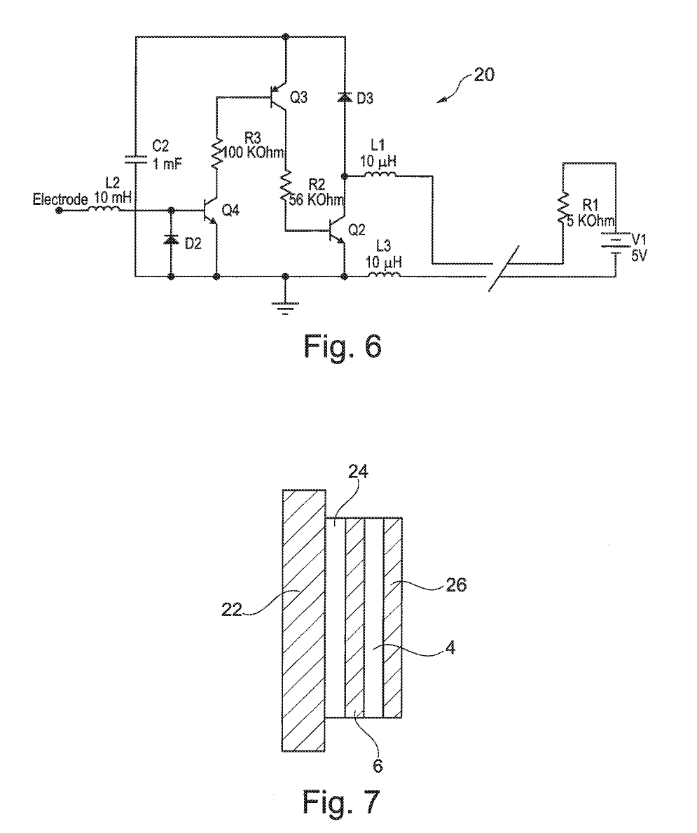

FIG. 6 shows a circuit diagram providing an open collector output square wave in accordance with one embodiment of the invention;

FIG. 7 shows a diagram of a sensor comprising layers of coating materials in accordance with one embodiment of the invention;

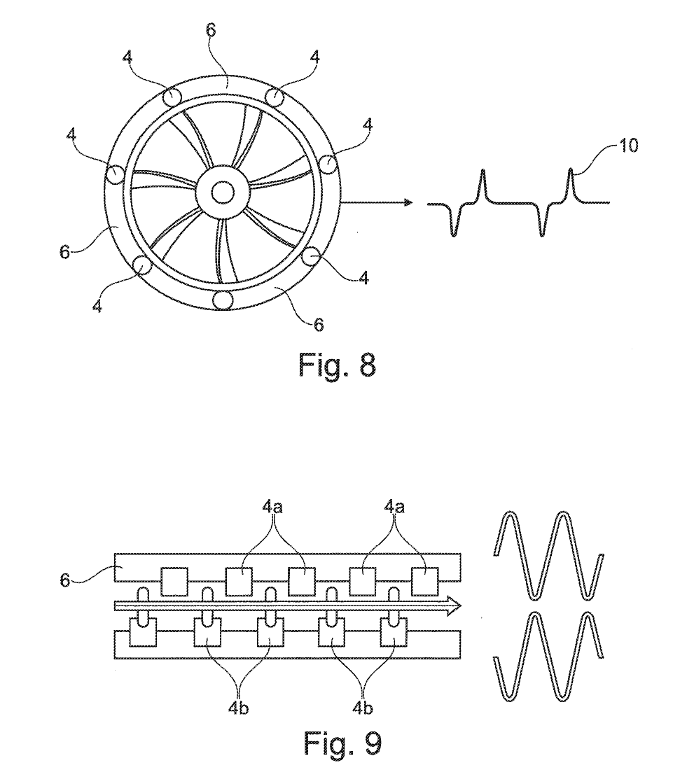

FIG. 8 shows a diagram of a sensor arranged as a ring in accordance with one embodiment of the invention;

FIG. 9 shows a diagram of an arrangement of a series of dielectrics in contact with a common band electrode in accordance with one embodiment of the invention;

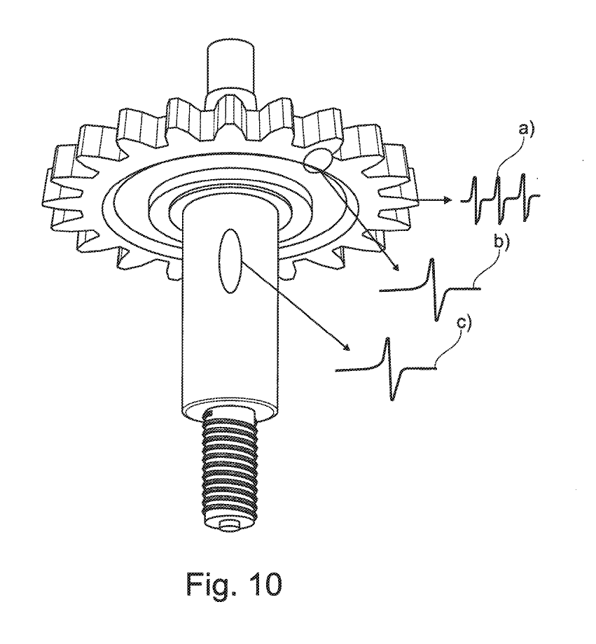

FIG. 10 shows a sensing wheel with sensor components applied at different locations in accordance with one aspect of the invention;

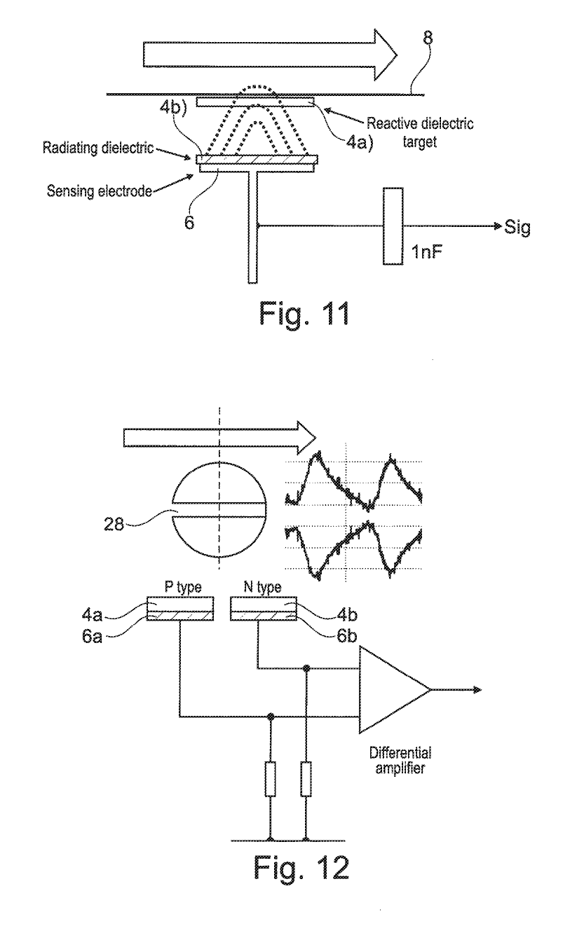

FIG. 11 shows a diagram of a sensor arrangement in accordance with one embodiment of the invention;

FIG. 12 shows a diagram of a sensor arrangement in accordance with one embodiment of the invention to provide opposite polarity signals for differential amplification;

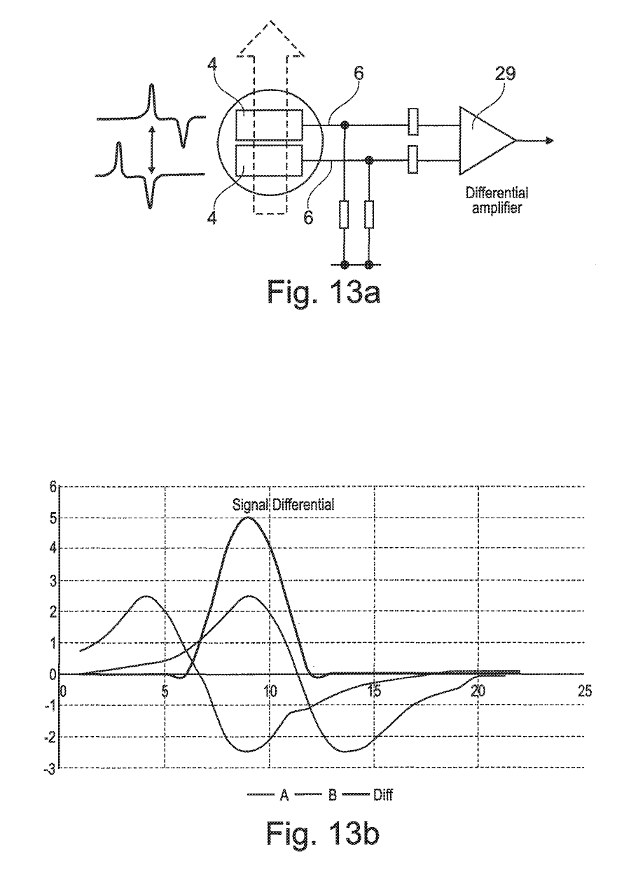

FIGS. 13a and 13b show a diagram of a sensor arrangement and signal output respectively in accordance with one embodiment of the invention;

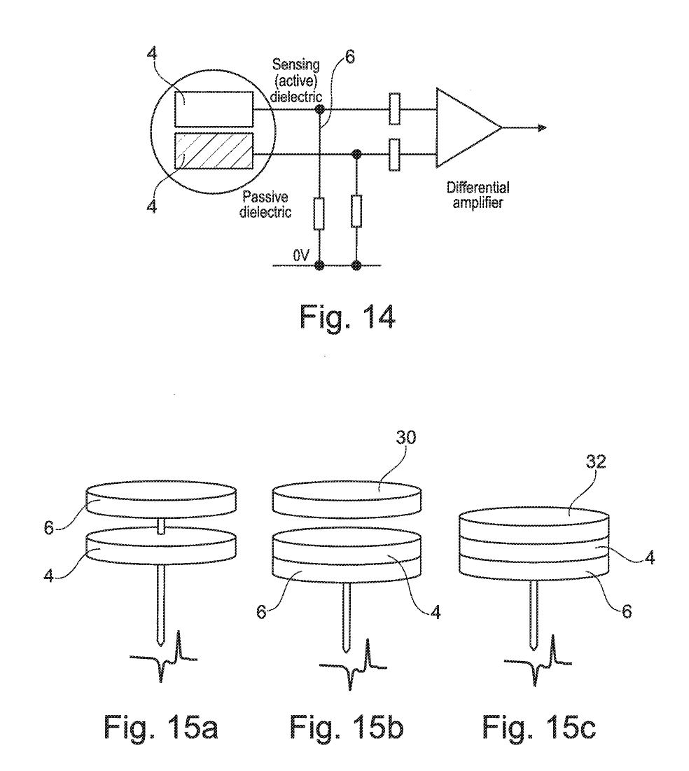

FIG. 14 illustrates a configuration of a sensor in accordance with one embodiment of the invention;

FIGS. 15a-15c illustrate various configurations of sensor in accordance with embodiments of the invention;

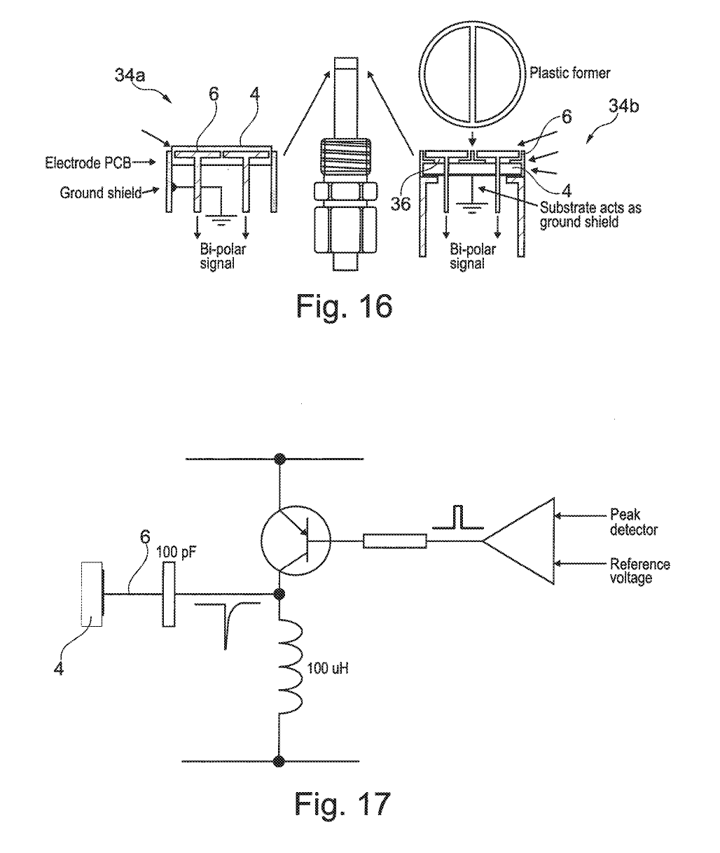

FIG. 16 show various probe sensor configurations in accordance with one embodiment of the invention;

FIG. 17 shows a diagram of a periodically charged sensor in accordance with one embodiment of the invention;

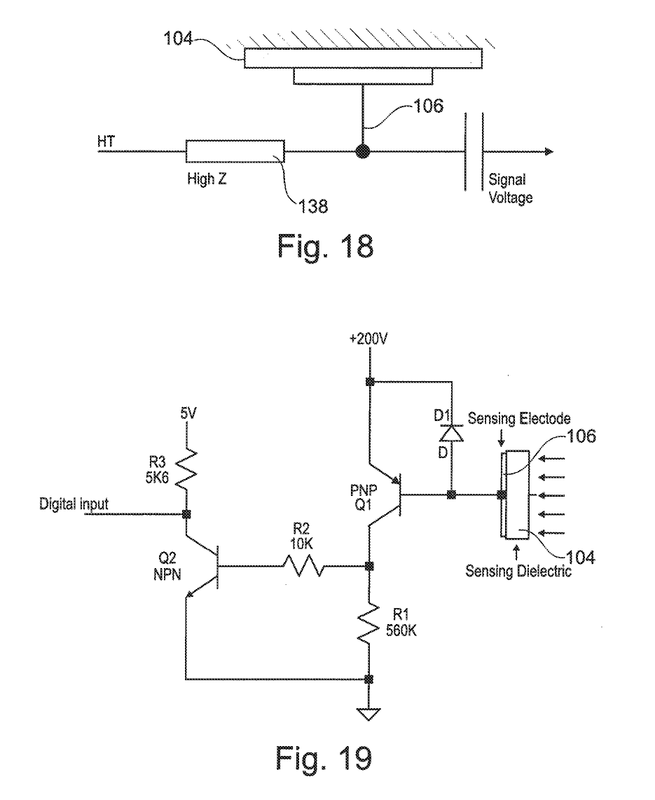

FIG. 18 shows an arrangement of a sensor in accordance with one embodiment of the invention;

FIG. 19 is a circuit diagram of a sensor using a transistor to create a high impedance field;

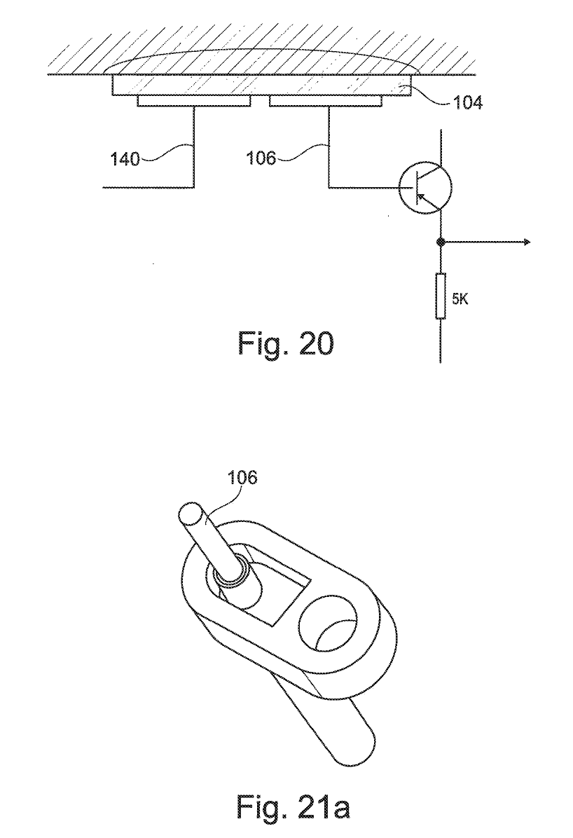

FIG. 20 shows an arrangement of a sensor in accordance with one embodiment of the invention where by using a shared dielectric the polarising electrode can be fed from a low impedance source whilst the sensing electrode has a high impedance;

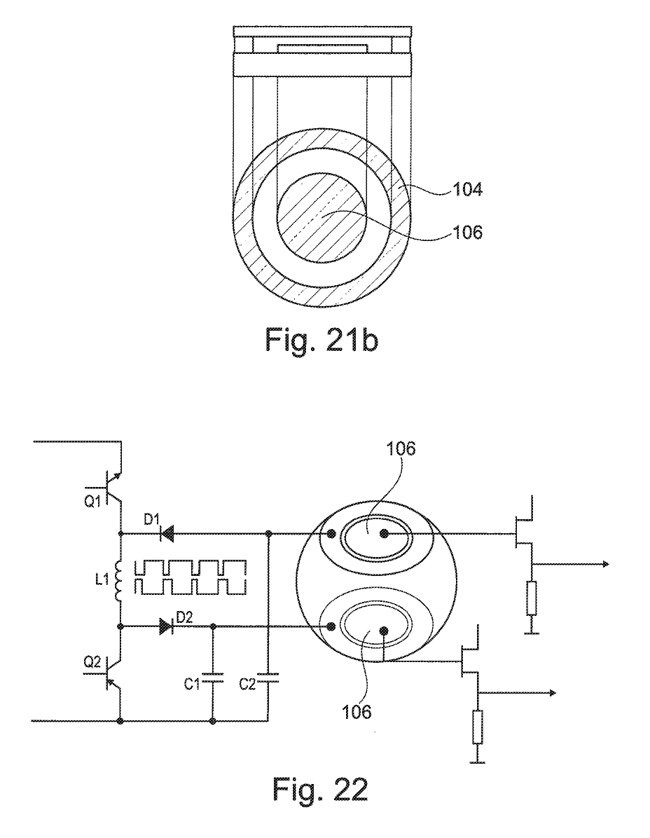

FIGS. 21a and 21b shows a coaxial arrangement of the sensor in accordance with one embodiment of the invention;

FIG. 22 shows a bipolar implementation of a sensor in accordance with one embodiment of the invention;

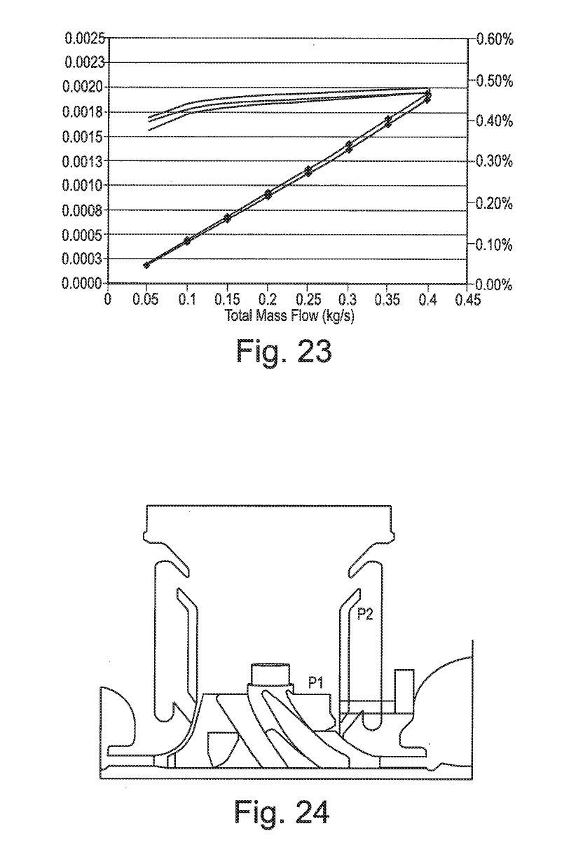

FIG. 23 shows a graph of the linear relationship of airflow measured against pressure differential;

FIG. 24 illustrates where the speed sensor in a turbocharger is situated;

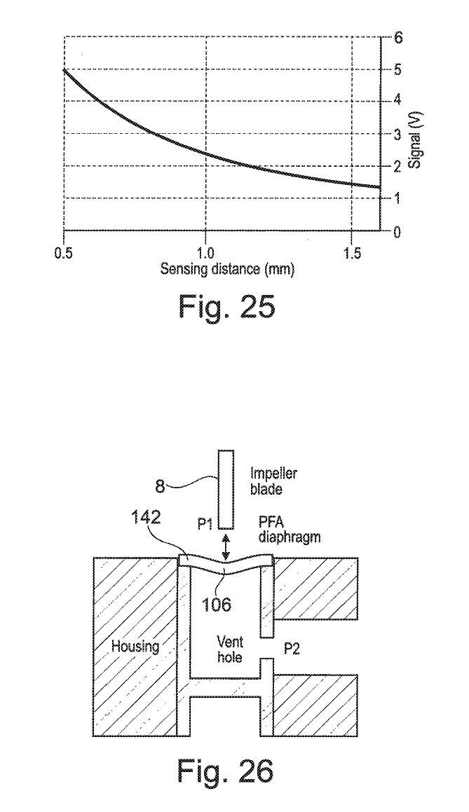

FIG. 25 is a graph showing speed signal amplitude against sensing distance;

FIG. 26 is an example of a sensor for a turbo in accordance with one embodiment of the invention;

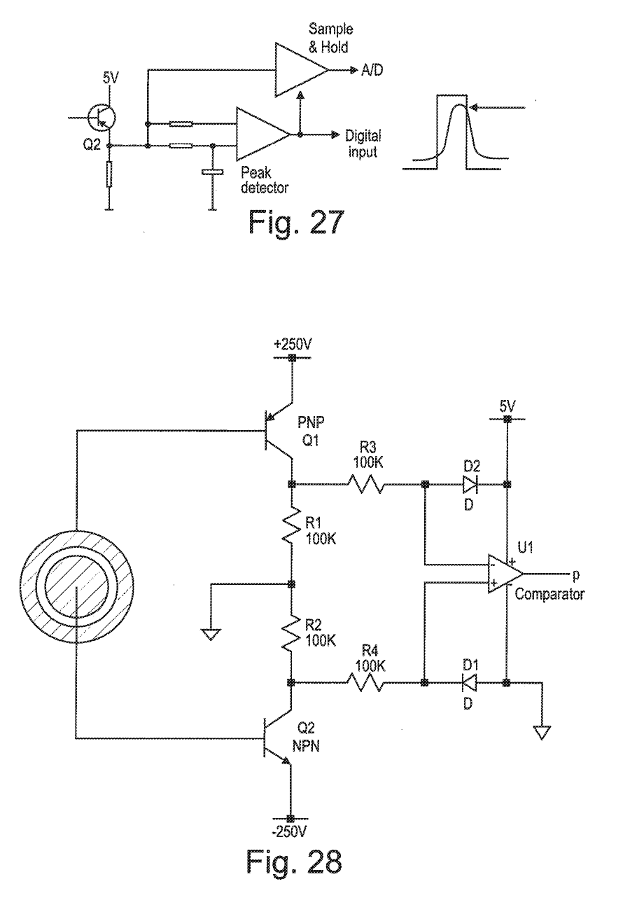

FIG. 27 shows a circuit diagram for a turbo sensor in accordance with one embodiment of the invention; and

FIG. 28 shows a sensor implementation with a differential output in accordance with one embodiment of the invention.

The invention concerns novel sensor technology for detecting the motion, of an object. Currently, the dominant technology for motion detection of machinery is inductive based. Optical sensors are not used because of their susceptibility to surface contamination. However, inductive sensors have severe limitations which sensing according to the present invention can overcome.

The technology is based on the ability of certain dielectrics to radiate a static electric field due to polarisation of the dielectric material. Polarisation can be formed by several means such as by triboelectricity, or by the influence of an electric field. Dielectrics being polarised in this way can sustain a surface charge for a period determined by their electret characteristic.

When a charge, emanating from a target object, intersects the field radiated from a sensing dielectric the interaction produces displacement current within the dielectric which causes a voltage change at a plate electrode in contact with the surface of the dielectric. This displacement current is in accordance with ‘electrostatic induction’ described by Maxwell's unified field theory.

Sensors that operate in hostile environments, such as for automotive, are typically based on inductive technologies. However, these have severe limitations, such as their inability: to detect slow speeds, detect non-ferrous metals and operate above 100° C. The proposed sensor can operate below 10 Hz, will detect almost any non-porous target material and can operate above 300° C.

Because both conducting (electrode) and non-conducting (dielectric) materials can be rendered as coatings the sensor manufacture can be implemented as a printing process. This allows sensor ‘nodes’ to be positioned to produce phased and additive signals.

Thus in summary, displacement sensing generates a signal as a result of a target object passing through an electric field causing an imbalance at the sensing electrode. The electric field will typically react with the targets surface irrespective of what material comprises the target. When a sensing dielectric is placed in front of the sensing electrode displacement current transfers the charge as with a capacitor. The signal amplitude is proportional to the sensing field intensity which may be the surface charge developed on the sensing dielectric. The signal amplitude is also a function of the field impedance which needs to be high.

### Definitions

The term ‘Hexoelectric property’ has been coined for this document as a convenient term for describing the ability of a dielectric material to polarise to form a charge at its surface. ‘Hexoelectricity’ refers to a signal propagated by the interaction of a Hexoelectric field with that of a target object.

‘N type’ refers to a dielectric radiating a negative charge field, and ‘P type’ a positive field.

### Theory of Operation

In a dielectric material the presence of an electric field causes the bound charges in the material to separate slightly to form a local electric dipole moment named by Maxwell as ‘displacement current’.

A charge field appearing at one surface of a dielectric will cause a dipole moment to exist until displacement current has flown sufficient to equalise the potential difference existing across the dielectric and its net charge is zero. This can be expressed as:

D=ε₀E+P

where: D=displacement current, ε0=permittivity of air, E=electric field density and P=polarisation of the dielectric medium.

FIG. 1 illustrates an example of a simple sensor 2 comprising a dielectric 4 and an electrode 6. The dielectric has a surface charge and its radiated charge field will produce displacement current or signal as it interacts with an external field. Most non porous materials will develop an ambient ground charge (0 V) unless they have a strong triboelectric property.

In this example a target 8 moving through the radiated charge field produces a displacement current or signal 10.

—Permanent Surface Charge

An electret is a dielectric that produces a permanent macroscopic electric field at its surface from ordering of its molecular dipoles. There are many suitable electret materials such as silicon dioxide and amorphous fluoropolymers. The charge can be implanted by the influence of a strong electric field, radiation or by ultra violet rays. For the sensor, a practical charge density is between 5 to 30 mC/m². The sensing dielectric can charged positive (P type) or negative (N type) according to the polarity of the applied charge field.

The sensing dielectric can be charged by applying a high potential (>100 V) to the sensing plate electrode.

There is a correlation between the triboelectric value of a dielectric and its effectiveness to produce a surface charge (H-exoelectric property). This applies to polarity and field density.

—Field Interaction

FIG. 2a shows an exposed N type dielectric 4 bonded to an electrode 6. The target 8 has a neutral field which reacts with the negative surface charge of the dielectric producing a positive charging current (i). As the target field moves away from the radiating dielectric field the dielectric recovers its ambient state causing displacement current to flow in the opposite direction producing a negative pulse as shown in FIG. 3.

FIG. 2b shows an embodiment where the target 8 includes a mobile P type dielectric 4 applied as a surface coating. The sensing element consists of a single electrode 6. The waveform produced as the positive dielectric field interacts with the neutral sensing electrode is as with FIG. 1a.

FIG. 2c is an enhanced version of FIG. 1b in that now the electrode 6 is bonded with an N type dielectric 4b. The field differential is increased between the P type dielectric 4a producing a signal of greater amplitude.

—Methods of Producing a Surface Charge

Surface charge on a dielectric can be produced in several ways:

1. Applying a Potential to the Electrode.

Applying a potential to an electrode in contact with a Hexoelectric polarises the dielectric to produce a charge at its surface. Away from the electrode, surface charge density of the dielectric forms a gradient which decreases with distance

2. Using a Triboelectric Material (Positive and Negative)

The molecular composition of some materials have an arrangement of natural ions so that the balance of charge is biased towards one electric polarity. This is particularly evident in some modern polymers. Materials with a surplus of electrons develop a negative surface charge whilst a positive ion majority causes a positive surface charge. The amount of charge that can be transferred within a material is measured in nano-Coulombs per Joule and is known as the triboelectric value. This is analogous to the electrochemical series of materials that describes the tendency of a material to gain or loss electrons. The action of air friction acting against the triboelectric surface can alter the charge density, and subsequently the signal amplitude.

Various dielectric materials were tested to check the relationship of pulse amplitude to the triboelectric value of the dielectric.

| Material | nC/J | Signal |
|---|---|---|
| Acetate | +100 | −2.3 V |
| Melinex 505 | +80 | −1.8 V |
| Acrylic | +52 | −1.2 V |
| Polyvinylidine Chlorate (PVC) | −90 | +2 V |
| Kapton | −110 | +2.5 V |
| PTFE/Teflon | −190 | +4.3 V |

These results show a signal amplitude relationship of 44 nC/J per Volt

3. Sustained Polarisation (Electret)

An electret is a dielectric that produces a permanent macroscopic electric field at its surface from ordering of its molecular dipoles. There are several methods available for electret formation and many suitable materials such as silicon dioxide and amorphous Fluoropolymers. In essence the dielectric coating material is applied in a fluid form and then set to a solid under the influence of a strong electric field which locks in the charge. Materials such as Teflon can be permanently charged by being subjected to a corona discharge. For the sensor, a practical charge density is between 5 to 30 mC/m².

In order to understand signal propagation, a single bladed wheel 11 was constructed to allow examination of a single transition as shown in FIG. 4. The disc 12 and vane 14 comprise grounded metal and the sensor 2 comprises an N type dielectric 4 bonded to an electrode 6 which returns to ground via a current meter (i) 16.

Electrostatic induction is analogous to electromagnetic induction so that current is only generated whilst there is a change of flux. Therefore, the approaching blade which carries an earth charge induces positive displacement current within the dielectric until the charge differential has stabilised after which no current is induced. As the blade departs the dielectric field collapses and produces displacement current flowing in the opposite direction until there is no further change when it decreases to zero as shown in the plot in FIG. 5.

—Formula

This formula describes a method of predicting signal amplitude from the sensor configuration shown in the FIG. 2a:

V=(E₁−E₂)A/D²kH

### Where:

V=signal amplitude (Volts)
E₁=dielectric surface charge (V/n
E₂=target field intensity (V/m)
A=target width
D=sensing distance (mm)
kH=Hexoelectric constant of the dielectric material

FIG. 6 shows a relatively simple circuit 20 providing an open collector output square wave.

### Surface Coating Applications

FIG. 7 shows a surface coating sensor comprising layers of materials.

To the metal body of the equipment housing 22 is applied an insulator 24 such as aluminium oxide. The next layer is the electrode 6 substrate and the sensing dielectric 4 follows and a surface modifier 26 is applied to reduce the dielectric surface conductivity.

All four layers may comprise a thickness of less than 100 μm in total.

If the sensing dielectric is not an electret then the surface charge can be produced by connecting a high voltage (>100 V) to the electrode layer until the desired level is reached.

Implementing Hexoelectric coatings as sensors and targets provides a vast array of applications.

The layers can be applied as a liquid or in powder form and then cured by heat or UV radiation resulting in an extremely thin and durable coating which can be applied by conventional low cost printing processes.

Their extremely thin nature and ability to withstand high temperatures, allow sensing functions to be implemented in the most restrictive and hostile locations. Also, being implemented as N or P types allows various phase polarity options and complex nodes.

—Ring Sensor

To enhance the signal, and reduce the input impedance, it is possible to connect a series of dielectrics in parallel. FIG. 8 shows an arrangement where Hexoelectric coatings 4 are applied to a common backplane electrodes 6 so that each sensing dielectric is aligned with a blade tip to make the signals additive. Interspacing a second ring will produce a signal 180° from the first for differentiation.

FIG. 9 shows an example of a series of P and N type dielectrics 4a, 4b are in contact with a common band electrode. 6. This could be implemented in the teeth of a cog wheel for example where alternative alignment with the P and N type dielectrics forms a composite sine wave.

—Flat Disc Coating

It is conventionally not possible to detect the rotation of a flat disc inductively unless it is physically modified in some way or different metals are used. A common practice for inductive sensors is to remove a portion of metal to create a change in sensing distance but this has the distinct danger of producing an imbalance to the rotation. Coating a shaft evenly with N and P type Hexoelectric material has no effect on balance as the overall thickness may be as small as only a few micrometres.

FIG. 10 shows a sensing a wheel at different points. The sensor may comprise a plain electrode or be an active dielectric.

### a) Tooth, b) Disc, c) Shaft

The target nodes may radiate a charge field by comprising an electret or by having a charge induced by the sensing field. If the node is, for example, a fluoropolymer then it will be polarised by the field radiating from the sensing electrode. There will be a distinct change at the sensing electrode as the metal wheel ground field is displaced by the reactive field emanating from the fluoropolymer node.

FIG. 11 shows a simple fluoropolymer target. As the target 8 incorporating a dielectric 4a moves to within the influence of the field radiating from the high voltage sensing electrode 6 it will react to produce a field displacement. The electrode 6 can optionally be coated with a dielectric 4b for safety and/or enhanced field differentiation.

### Noise Reduction by Differentiation

In any sensing system, one of the greatest threats is that of electrical noise. As most sensors rely on amplification to produce a signal it is likely that the noise signal will be amplified along with the sensed signal to produce a spurious output.

Differentiation is a major tool used to combat noise but it requires that the signal be split into opposite phases. In this way, any noise spike being picked up will affect both inputs equally whilst maintaining the differential on which the detection operates.

The two methods described here use a sensing electrode disc split into two to produce bipolar and antiphase solutions.

—Simultaneous Bipolar Signal

FIG. 12 shows an example where the target 28 is the blade of a grounded metal impeller wheel. Interacting with the P and N type dielectrics 4a,4b, the blade produces two simultaneous inputs of opposite polarity ideal for differential amplification.

—Phase Differential

FIGS. 13a and 13b show that using an N type Hexoelectric, the target will induce a positive excursion as it moves over the first (leading) sensing electrode. As it crosses the boundary separating the second electrode the field collapses to produce a negative excursion. At the same time as the field from the first electrode is collapsing the field from the second (lagging) electrode is building to produce a positive excursion which coincides with the negative excursion of the leading electrode. The differential amplifier 29 is configured in such a way that it provides the largest signal at the transition point between electrodes, Care must be taken to ensure that the sensor head is aligned so that the electrode partition coincides with the target and the direction of travel. This can be adjusted by rotating the circular head until the peaks are in alignment.

—Single Input Noise Rejection

FIG. 14 shows a configuration wherein one of the two electrodes is coated with a Hexoelectric whilst the other has a non-reactive coating and acts as a midpoint reference for the Comparator. The signal is present at the active Hexoelectric electrode whilst the dormant electrode has no surface charge other than that scavenged from the active electrode. The circuit is in perfect balance so any common mode noise will affect both inputs equally.

### Protecting the Surface Charge

The exposed sensing dielectric surface is vulnerable to the effects of moisture and other agents likely to conduct away the surface charge. This can be protected by imposing a low permittivity barrier layer over the charged sensing surface which cannot form a discharge path, yet will allow the Hexoelectric field to penetrate and react with the charged layer of the sensing dielectric to produce the required signal.

FIGS. 15a-15c show three ways of imposing a barrier layer.

In configuration shown in FIG. 15a the sensing electrode 6 acts as an outer protective layer with a small air gap between the dielectric 4 acting as the barrier. The electrode signal passes through the dielectric. When assembled into the sensor body this will form a hermetic seal.

In the configuration shown in FIG. 15b the sensing electrode 6 is in contact with the dielectric 4 with the outer metal cover 30 being isolated. The air gap between the dielectric and outer shield is hermetically sealed.

In configuration shown in FIG. 15c the sensing electrode 6 is in contact with the dielectric 4 surface. A solid barrier 32 is applied to the external surface of the sensor.

Electret dielectrics can be divided into two groups, SiO₂-based inorganic and polymer-based organic.

If the dielectric 4, in the configuration shown in FIG. 15c, is a, polymer type such as Teflon AF then the barrier layer 32 could be hexamethyldisilazine (HMDS). If the dielectric is a silicon dioxide type then the barrier could be silicon nitride.

These protective measures are unnecessary if the sensing dielectric is connected to a potential to replenish depleted ions.

### Probe Construction

FIG. 16 shows two possible implementations of a probe style sensor 34.

The left arrangement 34a is a standard PCB with two semi-circular copper plains 6 forming the electrodes. This is surface coated with a sensing dielectric 4 treated with a surface protection.

The arrangement on the right uses a hermetically sealed air gap 36 as an ion barrier with the sensing electrodes 6 on the exposed surface.

Thus the present invention provides a sensor wherein the operating principle is of electrostatic induction. In addition, it uses surface charge radiating from a dielectric. Furthermore, it does not rely on a high voltage being applied to the electrodes.

In a further aspect the probe sensor is a single unit which produces a simultaneously differential output. The differential is by phase or bipolarity. Furthermore, the sensor will detect active dielectrics used as markers on metal objects

### Dynamic Charge Control for a Semi-Permanent Electret

FIG. 17 shows an arrangement of the invention where a voltage at the electrode 6 creates a surface charge on the dielectric 4. The voltage at the electrode may be intermittent. It is only necessary to charge the dielectric for a few milliseconds and the charge will then be sustained for up to an hour depending on the moisture content of the air. In this arrangement the signal amplitude is monitored to top up the dielectric when it falls below a prescribed value.

The circuit in FIG. 17 can utilise a method by which the charge may be maintained at a substantially constant value. When the signal amplitude falls below the prescribed value presented by the reference voltage then the control circuit will generate charging pulses to the electrode until the dielectric charge at its surface has been restored to its operating level. This method of maintaining the dielectric charge may also be in the form of pulsed DC.

For simplicity of manufacture and to minimise power consumption the control circuit may be removed and the charging voltage applied as a mark-space ratio (duty cycle).

### High Voltage Transistor Sensor Application

FIG. 18 shows a typical arrangement where the sensing electrode 106 is energised by an external voltage. The series resistor 138 needs to be several Mega ohms for a sufficiently high impedance field and the signal is taken directly from the high voltage electrode for amplification.

The sensing field produces the largest modulation when the impedance is high but this makes the electronics vulnerable to radiated interference. Using the emitter base junction of a bipolar transistor, as shown in FIG. 19, as the field source to polarise the sensing dielectric 104 has the advantage of combining the sensing mechanism and field generator.

The circuit shown in FIG. 19 uses the transistor's base-emitter junction to create a high impedance sensing field. Disruption of the sensing field radiating from the surface of the sensing dielectric 104 by interaction with a target object produces changes to the base emitter voltage which in turn allow amplified current to flow from the collector. The collector signal in this circuit is typically 50 V peak to peak which is used to switch a 5 V transistor. With an applied voltage of 200 V and a 10 MΩ series resistor the signal from the sensor set up in FIG. 18 will typically be 500 mV. This circuit will work from a very wide voltage range, typically 5V to 1 kV, according to the application.

### Surface Coupling

Referring back to FIG. 18, when the arrangement is a typical means of generating a signal where the voltage developed across a high value resistor is modulated by the dielectric. With this method the signal amplitude is proportional to the applied voltage and the value of the resistor. In order to obtain a useable signal from a 100 V source the resistor needs to be several mega ohms and is susceptible to noise interference.

FIG. 20 shows an arrangement wherein by using a shared dielectric 104 the polarising electrode 140 can be fed from a low impedance source whilst the sensing electrode 106 has a high impedance.

In this arrangement the low impedance polarising voltage is applied directly to the energising electrode 140 which creates a surface charge on the dielectric 104 which extends above the sensing dielectric. The sensing electrode 106 applies no loading to the field so as not to attenuate the signal which is sufficient to control a bipolar transistor configured as an impedance buffer to provide a 5 KΩ output.

Turning now to FIGS. 21a and 21b which shows a potential coaxial arrangement of the probe described in FIG. 20. The inner core forms the sensing electrode 106 whilst the outer screen provides the polarisation for the dielectric 104 covering the sensing surface of the probe. FIG. 22 shows a bipolar implementation using ±300V with a flat disc printed circuit forming the electrodes. The sensing electrodes 106 are connected to P and N channel MOSFETs which act as impedance converters. The dual polarity produces a differential signal for very high common mode immunity. The printed circuit forming the electrodes is mounted as the sensing surface of the sensor.

### Mass Airflow

The conventional mass airflow sensor of a turbocharger sits inside the air intake channel, a position which is difficult to access without dismantling the pipework. This type of sensor is notoriously inaccurate and produces swirl which can effect turbo efficiency. One reason for its unreliability is the change of thermal mass caused by the hot wire which bakes oil droplets onto its surface.

### Currently Available Technologies Summary

| Type | Technology | Accuracy | Drawbacks |
|---|---|---|---|
| Vane | Mechanical | Low | Rotor subject to mechanical failure |
| Hot wire | Thermal | Medium | Surface deposits affect thermal |
| | | | mass |
| Inductive | Coil | Medium | Dependant on air vane |
| Karman | Optical | Medium | Surface contamination on optics |
| Karman | Plezo | Medium | Narrow airflow range |
| Membrane | Plezo | Medium | Requires large surface area |
| Orifice | P. transducer | High | Not suitable for mounting |
| plate | | | |

All the listed technologies suffer from major inaccuracies apart from the orifice plate which is based on the pressure differential existing upstream and downstream of the turbo impeller, A major advantage of this method is that it is independent of the conditions affecting air density: humidity and temperature.

The positioning of a sensor where the inlet and outlet pressures can be sampled is basis for a very accurate device.

FIG. 23 shows a graph of the linear relationship of airflow measured against pressure differential.

The speed sensor in a turbo is situated at a point where it is in proximity to the blade tips of the impeller. Here the air is being compressed P1 for feeding into the engine, as indicated in FIG. 24. The probe body of the sensor passes through the MWE slot which feeds into a position higher up the intake channel P2.

By making the sensed speed signal amplitude a function of the pressure differential then a combined output of speed and airflow can be delivered from the one sensor. FIG. 25 is a graph showing speed signal amplitude against sensing distance.

FIG. 26 is an example of such a sensor where a sensing 106 electrode is metalized on the centre of a flexible membrane 142. As the pressure differential increases the electrode 106 is displaced further from the target 8 thus reducing signal amplitude.

P1 is exerted against the front face of the membrane whilst P2 is vented into the sensor body to act against the back face.

The circuit for such an arrangement is shown in FIG. 27. The signal is developed across the emitter resistor of a bipolar transistor as shown previously and fed to two op amps. The peak detector is configured as a ‘change of slope detector’ which produces a square wave from any signal in the range of 0.5 V to the 5 V rail. This signal is fed into the MCU as the pulse count. The falling edge of the peak detector samples the signal voltage which is locked to the A to D input of the MCU to form a consistent value. This value will alter in accordance to signal amplitude which is the P2/P1 differential.

Compressed air is transported between impeller vanes and the pressure exerted against the sensor will vary slightly according to its rotary position. A huge advantage to this system, which increases accuracy, is that the blade position, and hence the pressure point, is a constant.

Another factor which increases reliability is that the sensor is self-calibrating. At 100 Hz impeller speed the airflow is insubstantial and can be used as a reference value. The signal amplitude at this point will be high and can be stored within the MCU memory as the zero airflow value. Subsequent (lower) measurements will be subtracted from the reference value to give the current airflow. Tests have shown an overall ‘S’ response curve which can be linearized by use of a look-up table in the microcontroller's memory. In addition, a simple thermistor can be sampled to compensate for differences in thermal flexibility of the membrane.

### Bipolar Sensing Using Transistor VBE

FIG. 28 shows a sensor implementation with a differential output, giving a very high transient noise rejection.

The base voltage of two transistors is used to polarise a sensing dielectric in contact with the radial electrodes. The target is assumed to have an ambient ground potential so that a simultaneous positive and negative signal is produced at the collectors.

D1 and D2 prevent the high voltage inputs exceeding the supply rails.

1. A sensor for sensing the relative movement between at least part of the sensor and one or more target objects, said sensor comprising:
at least one polarised or at least partially polarised dielectric and a polarising electrode operable to induce at least partial polarisation of the dielectric material to generate a static field of the dielectric, wherein the interaction of the one or more target objects with the static electric field of the dielectric produces a signal in a sensing electrode.

2. A sensor according to claim 1 wherein the sensor is a probe sensor having a coaxial arrangement, wherein an inner core of the coaxial arrangement comprises the sensing electrode, wherein the polarising electrode comprises an outer screen of the coaxial arrangement of the probe sensor.

3. (canceled)

4. A sensor according to claim 1 wherein an active charge remains on the dielectric such that the dielectric operates as an electret when a polarising potential is applied to the dielectric is reduced.

5. A sensor according to claim 1 wherein the sensor includes control circuitry, the control circuitry is operable to provide a charging current to the polarising electrode until a dielectric charge of the dielectric material is restored to, or above, a predetermined value.

6. (canceled)

7. (canceled)

8. A sensor according to claim 5 wherein the charging current is in the form of pulsed DC.

9. (canceled)

10. A sensor according to claim 1 wherein the at least one dielectric and the sensing electrode are in contact.

11. A sensor according to claim 1 wherein the dielectric and sensing electrode are not in contact or are a spaced distance apart.

12. A sensor according to claim 1 wherein the dielectric material is associated with the one or more objects to be detected.

13. A sensor according to claim 1 wherein the sensing electrode includes a plate electrode.

14. (canceled)

15. (canceled)

16. A sensor according to claim 1 wherein the dielectric material is configured to radiate a positive (P type) or a negative (N type) charge field according to a polarity of a potential connected to the polarising electrode.

17. A sensor according to claim 1 wherein at least part of the sensing surface dielectric is a coating.

18. (canceled)

19. (canceled)

20. A sensor according to claim 1 wherein the sensor includes a series plurality of dielectrics or dielectric materials.

21. A sensor according to claim 20 wherein the plurality of dielectrics are connected in parallel.

22. A sensor according to claim 20 wherein the plurality of dielectrics are connected by a common sensing electrode.

23. A sensor according to claim 20 wherein the plurality of dielectrics are each coupled to a different sensing electrode.

24. (canceled)

25. (canceled)

26. (canceled)

27. A sensor according to claim 1 wherein the sensor includes two or more dielectrics, at least one of said two or more dielectrics being a positively charged (P type) dielectric and at one of said two or more dielectrics being a negatively charged (N type) dielectric.

28. A sensor according to claim 27 wherein the interaction with the electric field produces signals that are of opposite polarity, wherein the signals that are of opposite provided polarity are provided to a differential amplifier.

29. (canceled)

30. (canceled)

31. (canceled)

32. A sensor according to claim 1 wherein the dielectric includes at least one protective surface or barrier layer.

33. (canceled)

34. (canceled)

35. (canceled)

36. (canceled)

37. (canceled)

38. A sensor according to claim 1 wherein the sensing electrode is the polarising electrode.

39. A sensor according to claim 2 wherein the dielectric covers a sensing surface of the probe sensor.
